(19) United States
(12) Patent Application Publication
(10) Pub. No.: US 2004/0078692 A1
(43) Pub. Date: Apr. 22, 2004

(54) Test configuration method and system

(76) Inventors: Walter A. Jackson, Pittsburgh, PA (US); Joseph F. Capezzuto, Jeannette, PA (US); Mitch Margaria, Avella, PA (US)

Correspondence Address: TEXAS INSTRUMENTS INCORPORATED, P O BOX 655474, M/S 3999, DALLAS, TX, 75265

(21) Appl. No.: 10/382,035

(22) Filed: Mar. 5, 2003

Related U.S. Application Data
(60) Provisional application No. 60/362,172, filed on Mar. 5, 2002.

(51) Int. Cl. G06F 11/00

(52) U.S. Cl. 714/38

(57) ABSTRACT

Methods for automating the process of testing software applications in multiple operating environments are provided. These methods broadly provide for making a stored image of an operating environment operable on a computer system, installing a software application in that operating environment, and executing tests on the application. These steps are executed on the computer system without human intervention once the testing process is initiated. The steps are repeated, without the need for human intervention, if the application is to be tested in more than one operating environment.

This application claims priority to provisional application Serial No. 60/362,172 (TI-34101PS).

### FIELD OF THE INVENTION

This invention generally relates to software development systems, and more specifically to improvements in testing software applications.

### BACKGROUND OF THE INVENTION

Software applications typically execute in a wide variety of operating environments. Before releasing these applications to the end users, they must be tested for correct operation in these operating environments. Generally, such system testing is accomplished by loading an operating environment on a computer system, installing the application software, and executing the desired set of tests. These steps are repeated for each target operating environment. Prior art testing systems provide automation support for creating and executing the desired tests but do little to aid in automating the time and/or resource consuming steps of loading each target operating environment and installing the application. As the number of target operating environments increases, techniques for automating this level of system testing of application programs become increasingly important.

### SUMMARY OF THE INVENTION

The present invention provides methods and systems for automating the process of testing software applications in multiple operating environments. Embodiments provide for an automatic operating environment change followed by automatic installation and testing of a software application.

### BRIEF DESCRIPTION OF THE DRAWINGS

Particular embodiments in accordance with the invention will now be described, by way of example only, and with reference to the accompanying drawings in which:

FIG. 1 presents a flow graph of a method for automatically testing a software application;

FIGS. 2-9 illustrate example input screens; and

FIG. 10 presents a general purpose computer system operable to execute a method for automatically testing a software application.

Corresponding numerals and symbols in the different figures and tables refer to corresponding parts unless otherwise indicated.

### DETAILED DESCRIPTION OF EMBODIMENTS OF THE INVENTION

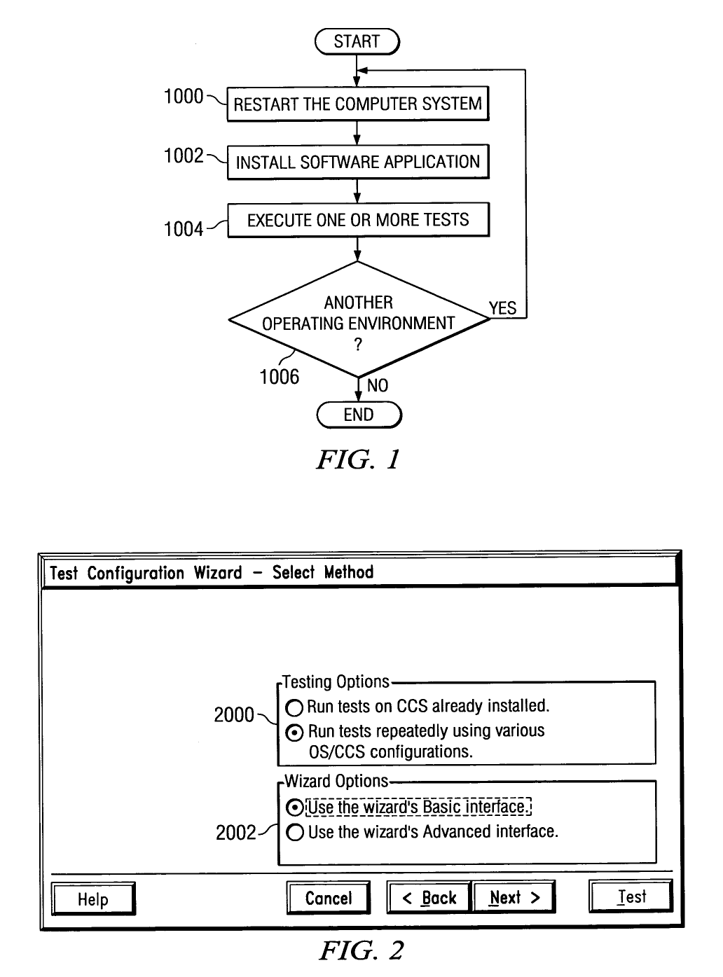

FIG. 1 presents a flow graph of a method for automatically testing a software application in one or more operating environments on a computer system. The steps of this method are accomplished without human intervention. At step 1000, the computer system is restarted such that a desired operating environment is executed on the computer system. The software application to be tested is installed in the executing operating environment at step 1002. The desired tests are executed and the results of the test execution are recorded (step 1004). As step 1006 illustrates, steps 1000-1004 are repeated if the software application is to be tested in more than one operating environment.

The method of FIG. 1 and alternative methods are best illustrated by way of an example using an embodiment of the invention. In this example, the software application to be tested is Code Composer Studio™ (CCS) from Texas Instruments Incorporated. However, one skilled in the art can readily understand how other embodiments may be used to test other software applications.

In an embodiment, the user is presented with a screen such as that of FIG. 2 that allows the user to select among several testing options. As testing options 2000 illustrates, the user may choose to run tests in the current operating environment in which the application is already installed or to run tests in other operating environments. Here the user has chosen the latter option. Wizard options 2002 allows the user to choose between a basic interface and an advanced interface. Here the user has chosen to use the basic interface, which permits the user to specify one group of test scripts to be executed in each operating environment.

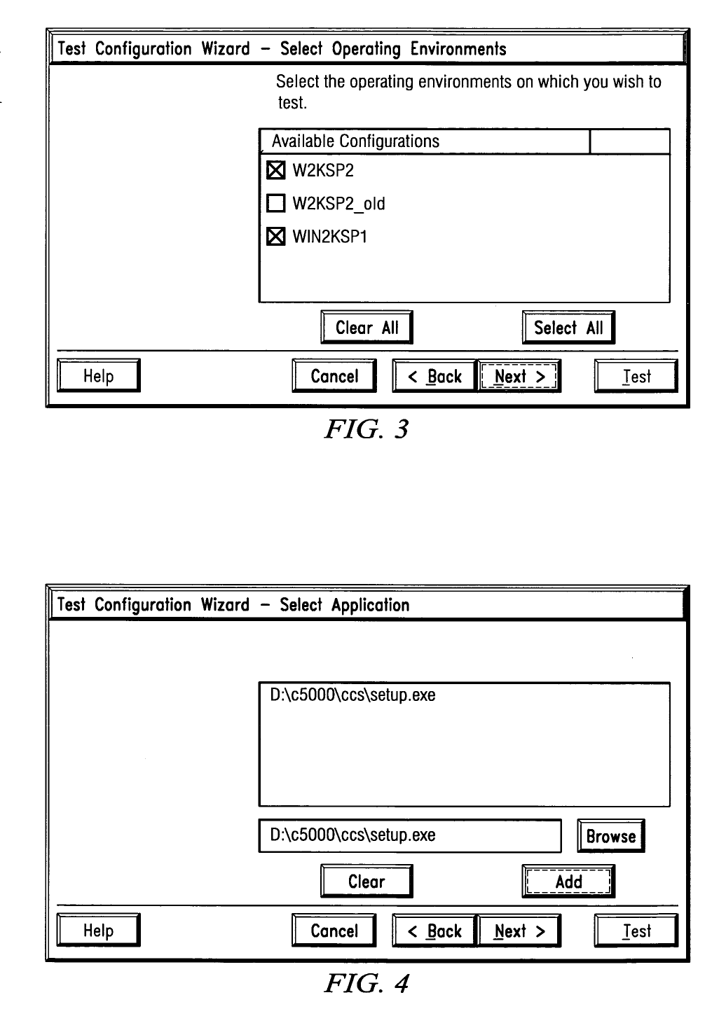

Next, as illustrated in the screen of FIG. 3, the user is presented with a list of the available operating environments in which the software application may be tested. The user may select one or more of these. Here the user has chosen two operating environments, W2KSP2 and WIN2KSP1.

The available operating environments are stored as image files on a disk installed in the computer system. Each operating environment is comprised of a version of an operating system that has been installed on the computer system and any software required to run tests on the software application. Each operating environment may additionally comprise other installed applications. To create an operating environment, the desired version of the operating system is installed on the computer system. Then, the additional software needed to execute tests on the software application and to record the results of those tests is installed. In this embodiment, such additional software comprises Rational® Robot available from Rational Software Corporation. Other software applications may be optionally installed to recreate anticipated operating environments of end users of the application to be tested. Other actions may also be taken to configure the operating environment appropriately for use in an automated test. For example, if the installed operating system has a login capability, it will be necessary to set up the operating system to permit automatic login each time it is booted. Once the desired operating environment is created, it is saved as an image file using a utility such as DriveImage® from PowerQuest Corporation.

Table 1 contains an example set of instructions for creating operating environments for an embodiment. These instructions are specifically designed for operating environments comprising one of the following operating systems: Windows® 98 Service Pack 1, Windows® 98 SE, Windows NT4 Service Pack 6, Windows® 2000 Service Pack 1 and Windows® 2000 Service Pack 2, all products of Microsoft Corporation. However, one skilled in the art will be able recognize the general requirements for creating an operating environment comprising other operating systems and other disk allocations from this example. The instructions assume that the computer system has a hard disk with the following three partitions: a 4 GB FAT32 partition named C; a 2 GB FAT partition named D; and a FAT32 partition that encompasses the rest of the disk named E. FAT and FAT32 are two versions of the File Allocation Table file system supported by one or more Microsoft operating systems. The C partition is the partition where the operating environments are created and where they are restored during the testing process. The D partition comprises files that are common to the testing process. The E partition is used to store the image files.

TABLE 1

| Step | Instruction |
|---|---|
| 1 | Install the operating system. For Windows 98, be sure to select the option that will bypass the |
| | Windows logon dialog box. |
| 2 | For Windows NT and Windows 2000, create an account with user name “test” and password |
| | “test”. Give administrator privileges to this account. |
| 3 | Log out and log in as test (to verify the successful grant of administrator privileges) and install |
| | Rational Robot. |
| 4 | Invoke Robot and set the playback options and logging options: |
| | In the login screen: |
| | Enter “admin” for User Name |
| | Click on Browse and enter the path to the Default.rsp project file in the File name |
| | box and click Open. |
| | Be sure that the location of Default.rsp appears in the Location box and that |
| | “Default” appears in the Project box. |
| | Click OK. |
| | Go into Tools->GUI Playback Options: |
| | Set the option for Error Recovery/Script Command Failure to “Skip current script”. |
| | Set the Log options to output results to log, use default log information and do not |
| | prompt before overwrite. |
| | Click OK |
| | Exit Robot. |
| 5 | Start Excel 2000 and click OK on the login dialog if it appears and turn off the paper clip guy. Exit |
| | Excel. |
| 6 | Add a short cut in the startup start menu for the D:\scripts\<operating environment>.bat file. |
| | (Note: <operating environment> is a unique name for the operating environment being created. |
| | This batch file is a dummy file that is replaced by an actual batch file when the user selects this |
| | operating environment for testing purposes.) |
| | In Windows Explorer, right-click on the D:\scripts\<operating environment>.bat file |
| | and select Copy. |
| | Right-click on Start and select Explore. |
| | Double-click Programs and then double-click Startup. |
| | Right-click in the window that displays the contents of the Startup folder and select |
| | Paste Shortcut. |
| 7 | On Windows NT, Windows 2000, update the registry to enable automatic logon: |
| | Click Start->Run and enter regedit into the Open edit box. |
| | Navigate to [HKEY_LOCAL_MACHINE\Software\Microsoft\ |
| | WindowsNT\CurrentVersion \Winlogon] |
| | Edit or add entries so that the following name/data pairs exist. |
| | If the name doesn't exist, right-click in the right-hand frame and select New->String |
| | Value or select the Edit->New->String Value menu item. Enter the name (no quotation |
| | marks). To edit the data, double click on the name and enter the desired value (do not |
| | use quotation marks). |
| | “AutoAdminLogon“=”1” |
| | “DefaultUserName“=”test” |
| | “DefaultPassword“=”test” |
| | This allows for automatic login after each reboot. |
| | Close the registry window. |
| 8 | If Windows NT, enable it to read the FAT32 E: partition: |
| | Insert the fat32.exe floppy. (Note: fat32.exe is available at http://www.sysinternals.com.) |
| | Run fat32.exe. |
| | Reboot. |
| 9 | On Windows NT and Windows 2000, create the BOOTSECT.DOS file (which allows the running |
| | of DriveImage, a DOS program, from the hard disk upon reboot): |
| | Put in a DOS boot disk. |
| | Reboot |
| | Type “dir c:”. If this doesn't display the files in the root directory of C:, then: |
| | Type “c:”. followed by Enter. |
| | Type “cd c:\” followed by Enter. |
| | Type “a:” followed by Enter. |
| | Type “sys c:” This copies the DOS system files to the root drive of C:. |
| | Next, let Windows know that DOS is on the system. The following step does the actual |
| | creation of BOOTSECT.DOS. |
| | On Windows NT: |
| | Put the Windows NT disk in the CD drive and reboot. Fix BIOS to boot from the |
| | CD if needed. |
| | Type “R” for Repair |
| | Uncheck the top 3 options and (make sure boot sector is the only one checked) |
| | Keep hitting Enter until it asks for the emergency repair disk and then hit Esc. |
| | Hit Enter to repair. |
| | Hit Enter to restart. |
| | For Windows 2000: |
| | Put the Windows 2000 disk in the CD drive and reboot. (Fix BIOS to boot from |
| | the CD if needed.) |
| | Type “R”. |
| | Type “R”. |
| | Select “manual” |
| | Uncheck the top 2 options. That is, only “Inspect boot sector” should be checked. |
| | Type “L”. |
| | Hit Enter. |
| 10 | On Windows NT, Windows 2000, make the boot.ini file able to be overwritten. |
| | Copy the contents of the c:\boot.ini file to the clipboard. |
| | Delete the c:\boot.ini file. (This removes special permissions on this file.) |
| | Create a new boot.ini file and copy the contents of the clipboard into this file. |
| | Save the file and make sure the permissions are not read-only. |
| 11 | On Windows 98 do the following to keep from getting the logon dialog box: |
| | Right-click on Network Neighborhood |
| | Select the Properties menu item. |
| | In the Primary Network Logon combo box, choose Windows Logon. |
| | Click OK. Restart if prompted. |
| 12 | Restart the computer system and boot from a DriveImage floppy disk. Create a DriveImage file for |
| | the operating environment at e:<OS>.pqi. Use the “High Compression” option. |

In addition, a reboot configuration file is created for each operating environment. Each reboot configuration file contains command lines that cause the image for the associated operating environment to be automatically restored and the computer system to be rebooted. In this embodiment, the reboot configuration files comprise an autoexec.bat file for each image. Table 2 contains a template for these autoexec.bat files. To create the required autoexec.bat file, the string <OS> in line 5 of the template is replaced with a unique identifier for the operating environment and the file is then stored on the D partition with a pathname comprising autoexec<OS>.bat. For example, for the selected operating environment W2KSP2, the pathname at line 5 is e:\W2KSP2.pqi and the file is stored as d:\scripts\autoexecW2KSP2.bat. The executable pqimgctr, referenced in line 5, is part of the DriveImage utility. It causes the desired image to be restored and the computer system to be rebooted.

TABLE 2

| | |
|---|---|
| 1 | @echo off |
| 2 | cls |
| 3 | d: |
| 4 | cd\scripts\pqdi |
| 5 | pqimgctr/cmd=d:\scripts\image.txt/img=e:\<OS>.pqi |
| 6 | REM The image in e:\<OS>.pqi is restored to partition c: and the |
| 7 | REM computer will automatically reboot |

Returning to the example, the user next selects the application to be tested in the specified operating environments. As FIG. 4 illustrates, in this embodiment, the application is selected by specifying the pathname of the installation file for the application. This installation file comprises means for installing the application on the operating system included in the operating environment without user interaction. Commercial software utilities such as InstallShield® Developer™ from InstallShield Software Corporation provide one way to create such installation files.

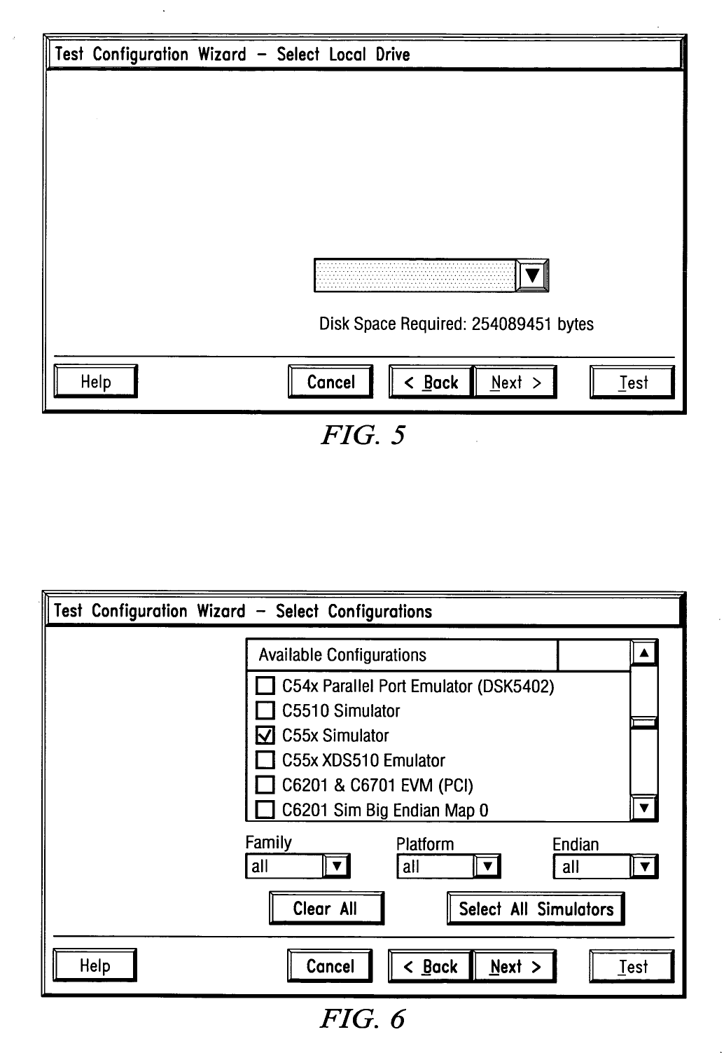

The files required to install the selected application do not necessarily have to be present on the computer system when the application is selected. However, they must be copied to the computer system before the test sequence is started. The screen of FIG. 5 allows the user to select a local disk drive to which the required files will be automatically copied. The required files may be located on any network accessible computer system.

If the application has a number of optional configurations or modes, the user may select one or more of these configurations for testing. As shown in FIG. 6, the available configurations are presented and the user chooses those required for the desired testing sequence. Here, the user has selected only the C55x Simulator configuration.

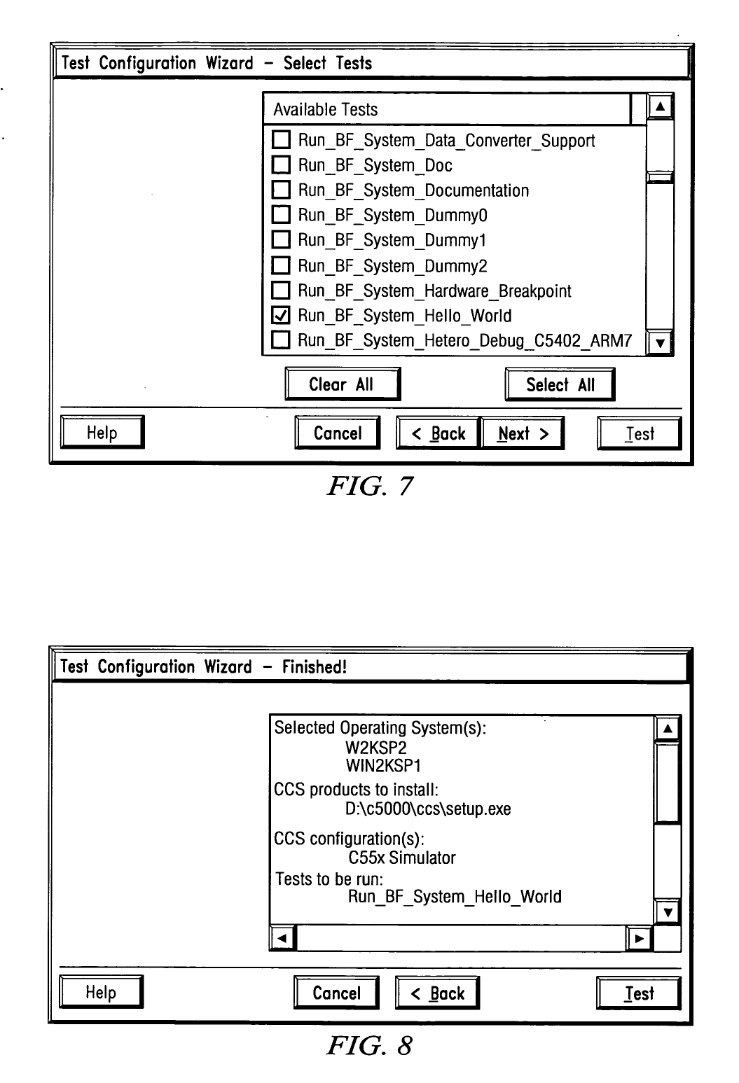

The user then selects the tests to be executed. A screen such as that of FIG. 7 presents the user with a list of the available test scripts and the user may choose one or more of them. Here, the user has selected only one test script, RUN_BF_System_Hello_World.

Finally, the user is presented with a confirmation screen such as that of FIG. 8. The user has the option to make changes if anything is incorrect. To start the testing process, the user clicks on the Test button.

Once the user starts the testing process, batch files are generated to automate the process of executing the selected tests in each selected operating environment. The batch files comprise an operating environment batch file for each selected operating environment and a test execution batch file. The operating environment batch files comprise commands to install the specified application, perform any initialization needed prior to test execution, call the test execution batch file to execute the selected tests, and to reboot the computer system with the next selected operating environment. The operating environment batch file for the final selected operating environment comprises commands to terminate the testing process. The test execution batch file, which is invoked by each of the operating batch files as needed, comprises commands to cause a selected configuration of the application to be loaded and to cause the user-specified tests to be executed.

Table 3 contains an example operating environment batch file for the selected operating environment W2KSP2. This example assumes that W2KSP2 is the last operating environment in which tests are to be executed, so lines 25 to 28 contain commands to terminate the testing process. The operating environment batch file for WIN2KSP1 would comprise similar commands but lines 25 to 28 are replaced with the lines shown in Table 4. The shutdown utility psshutdown referenced in line 5 of Table 4 is freeware from www.sysinternals.com that is operable to cause WindowsNT 4.0 and Windows 2000 to shutdown and to cause the computer system to restart automatically after shutdown. An alternative shutdown utility, rundll32, provided as part of the Windows 98 operating systems, may be used to perform the same operations for those operating systems. Line 21 of Table 3 contains an example of a call to the test execution batch file. This line is replicated with appropriate parameters for each user-selected configuration.

Table 5 contains an example test execution batch file. Line 10 is replicated with appropriate parameters for each user-selected test.

TABLE 3

| | |
|---|---|
| 1 | REM If file C:\Done.txt exists, assume that this batch file has already been run. |
| 2 | if exist C:\Done.txt goto End |
| 3 | REM If C:\CCSProduct.txt already exists, assume have just rebooted after the CCS |
| 4 | REM install; skip over the call to install_ccs. |
| 5 | if exist C:\CCSProduct.txt goto SkipInstall |
| 6 | REM Create a file giving the location of the CCS setup.exe. |
| 7 | echo D:\c5000\ccs\setup.exe > C:\CCSProduct.txt |
| 8 | REM Call Rational Robot to install CCS, supplying appropriate parameters to ensure that |
| 9 | REM the installation process does not require user interaction. |
| 10 | “C:\Program Files\Rational\Rational Test\rtrobo.exe” install_ccs /user admin/ |
| | project “Q:\CCS22\CCS.rsp” /play /build “2.20.00.04”/logfolder Default /log |
| | Install_CCS /close |
| 11 | REM Reboot the system if the installation did not write the ccs_Compdb.ini file. |
| 12 | if not exist “C:\Program Files\Common Files\Texas |
| | Instruments\ccs_Compdb.ini” D:\scripts\psshutdown.exe -t 1 -f -r -1 |
| 13 | if not exist “C:\Program Files\Common Files\Texas |
| | Instruments\ccs_Compdb.ini” goto End |
| 14 | :SkipInstall |
| 15 | REM Set Robot's playback settings and create the build folder to be used for |
| 16 | REM these log files. |
| 17 | D:\tcw\InitialSetup.exe |
| 18 | REM Reset the test account to regular user. |
| 19 | net localgroup administrators test/delete |
| 20 | REM Call the batch file to run the tests for each selected configuration. |
| 21 | call RunTests.bat c55xsim.ccs |
| 22 | REM If there multiple configurations were selected, the above line is repeated |
| 23 | REM for each configuration name. |
| 24 | REM This is the last batch file to be run. Clean up. |
| 25 | del C:\autoexec.bat |
| 26 | del C:\boot.ini |
| 27 | copy D:\scripts\boot.good C:\boot.ini |
| 28 | echo done > C:\Done.txt |
| 29 | :End |

TABLE 4

| | |
|---|---|
| 1 | del C:\autoexec.bat |
| 2 | copy D:\scripts\autoexecW2KSP2,bat C:\autoexec.bat |
| 3 | del C:\boot.ini |
| 4 | copy D:\scripts\boot.ini C:\boot.ini |
| 5 | D:\scripts\psshutdown.exe -t 15 -f -r -1 |
| 6 | :End |

TABLE 5

| | |
|---|---|
| 1 | REM If the given .ccs file doesn't exist in C:\ti\drivers\import, just exit the script. |
| 2 | if not exist C:\ti\drivers\import\%1 goto Error |
| 3 | REM Write the name of the .ccs file to a text file. |
| 4 | echo %1 > C:\CCSName.txt |
| 5 | REM Create the log folder to be used for these tests. |
| 6 | D:\tcw\CCSTestSetup.exe |
| 7 | REM Invoke Robot to configure CCS. |
| 8 | “C:\Program Files\Rational\Rational Test\rtrobo.exe” Configure_CCS /user |
| | admin /project “Q:\CCS22\CCS.rsp” /play /build “2.20.00.04” /logfolder Default /log |
| | Configure_CCS /close |
| 9 | REM Run the selected test scripts |
| 10 | “C:\Program Files\Rational\Rational Test\rtrobo.exe” |
| | Run_BF_System_Hello_World/user admin /project “Q:\CCS22\CCS.rsp” /play/ |
| | build “2.20.00.04” /logfolder Default /log Run_BF_System_Hello_World /close |
| 11 | REM The above command line is replicated for each selected test script |
| 12 | goto End |
| 13 | :Error |
| 14 | echo %1 DOES NOT EXIST —skipping these tests |
| 15 | echo %1 DOES NOT EXIST —skipping the tests using this configuration>> |
| | D:\scripts\Errors.txt |
| 16 | echo Run_BF_System_Hello_World>> D:\scripts\Errors.txt |
| 17 | REM The above command line is replicated for each selected test script |
| 18 | :End |

After the batch files are created, the computer system is configured so that it can be rebooted with the first selected operating environment. In this embodiment, the boot.ini file in the c partition is replaced by a boot.ini file that causes the Microsoft DOS operating system to be started the next time the computer system is booted. Table 6 contains an example of such a boot.ini file. The autoexec<OS>.bat file for the first selected operating environment, autoexecWIN2KSP1.bat, is copied to replace the autoexec.bat file in the c partition. Then the appropriate shutdown utility is executed to shut down and reboot the computer system. The testing process then executes as follows:

1. The computer system is rebooted with the DOS operating system as per the boot.ini file.

2. Thee autoexec.bat file is executed, causing the image file for WIN2KSP1 to be restored and the computer system to be restarted with that operating environment operative.

3. The WIN2KSP1.bat file, which was made part of the startup process when the operating environment was created (see line 5 of Table 1), is executed. The application is installed (see line 10 of Table 3) and the test execution batch file RunTests.bat is called with the selected configuration as a parameter (see line 21 of Table 3).

4. The selected configuration is applied to the installed application (see line 8 of Table 5) and the user-specified test scripts are executed (see line 10 of Table 5).

5. The boot.ini file in the c partition is replaced by a boot.ini file that causes the Microsoft DOS operating system to be started the next time the computer system is booted. The autoexec<OS>.bat file for the next selected operating environment, autoexecW2KSP2.bat, is copied to replace the autoexec.bat file in the c partition. Then the appropriate shutdown utility is executed to shut down and reboot the computer system. (See Table 4)

6. Steps 1-4 are repeated with the appropriate image and batch files for W2KSP2.

7. W2KSP2 is the final selected operating environment, so the test process is terminated. (See lines 25-28 of Table 3).

TABLE 6

| | |
|---|---|
| 1 | [boot loader] |
| 2 | timeout=3 |
| 3 | default=c:\ |
| 4 | [operating systems] |
| 5 | multi(0)disk(0)rdisk(0)partition(1)\WINNT=“Bypass imaging |
| | operation” |
| 6 | multi(0)disk(0)rdisk(0)partition(1)\WINNT=“Windows NT |
| | Workstation Version 4.00 [VGA |
| | mode]” /basevideo /sos |
| 7 | c:\=“Microsoft Windows” |

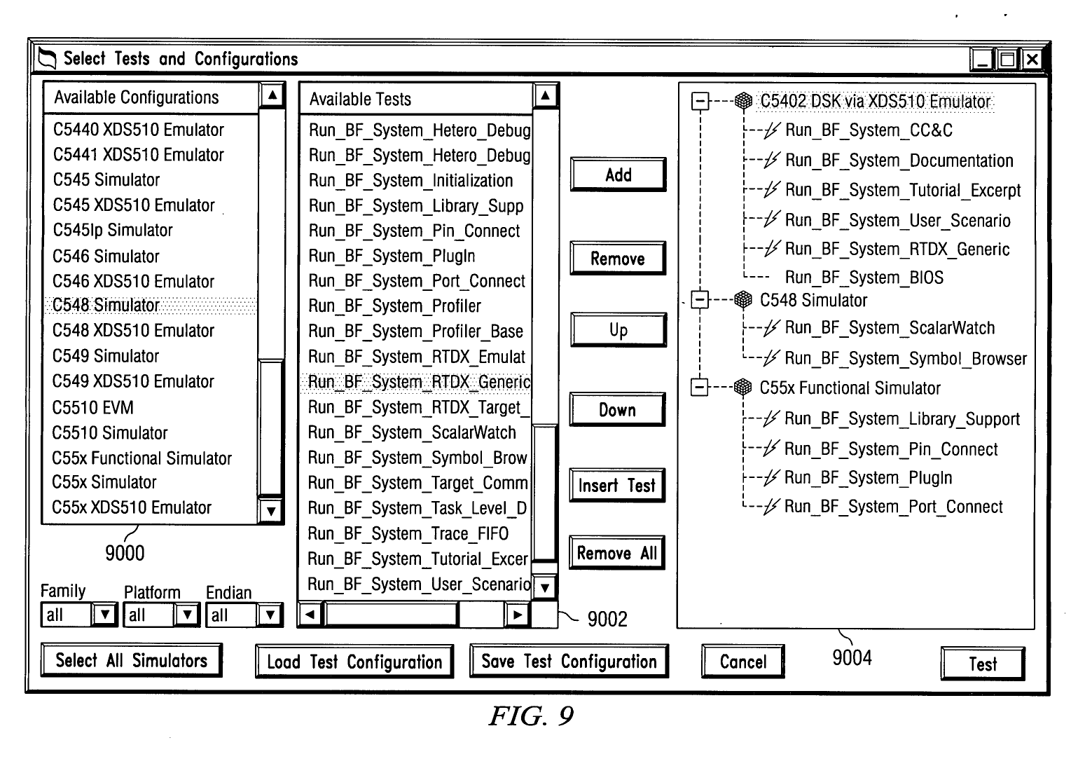

In the above embodiment, a single application is tested and the same set of tests is executed in each selected operating environment. However, this is not a limitation of the invention. In other embodiments, the ability to automate the test process with differing combinations of operating environments, applications, test sets, and configurations is provided. For example, different sets of tests may be selected for each configuration. FIG. 9 is an example screen in which the user may associate different sets of tests with selected configurations. Pane 9000 displays the available configurations, pane 9002 displays the available tests, and pane 9004 displays the selected configurations and the tests selected for each of these configurations. Analogously, differing combinations of operating environments, applications, configurations, and/or test sets may be specified. Appropriate combinations of batch files are then generated to cause the automatic execution of the specified testing process.

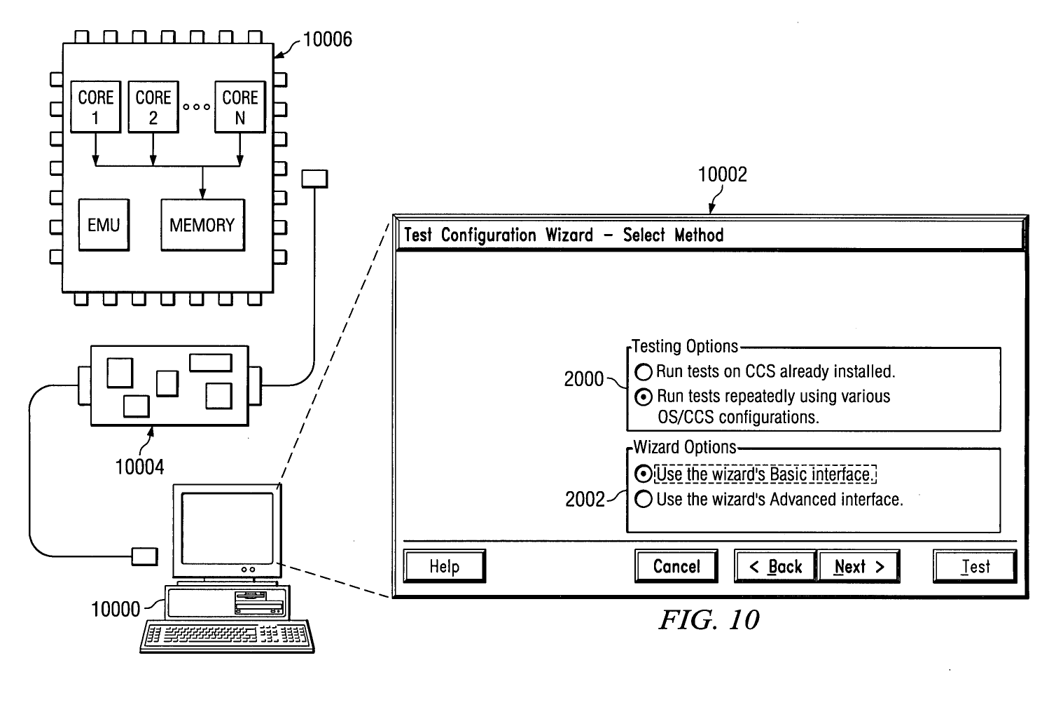

FIG. 10 illustrates the elements of a system operable to execute the methods described herein. General-purpose personal computer 10000 is connected to target hardware 10006 with emulation controller 10004. Test configuration software embodying one or more of the methods described above, as represented by screen 10002, is installed on general-purpose computer 10000. Target hardware 10006 and emulation controller 10004 are optional. They will only be present if required by a software application to be tested.

While the invention has been described with reference to illustrative embodiments, this description should not be construed in a limiting sense. Various other embodiments of the invention will be apparent to persons skilled in the art upon reference to this description. For example, custom software may be written or commercially available software utilities other than those mentioned herein may be used to perform some or all of the aspects of the invention. Additionally, any operating system that may be installed on the computer system may be used so long as it may be configured in such a way as to permit operation without user interaction.

It is therefore contemplated that the appended claims will cover any such modifications of the embodiments as fall within the true scope and spirit of the invention.

InstallShield and Developer are trademarks or registered trademarks of InstallShield Software Corporation in the United States and/or other countries. Windows and Microsoft are trademarks or registered trademarks of Microsoft Corporation. Code Composer Studio is a trademark or registered trademark of Texas Instruments Incorporated. Rational is a registered trademark of Rational Software Corporation. DriveImage is a registered trademark of PowerQuest Corporation.

What is claimed is:

1. A method for testing a software application on a computer system comprising the steps of:
restarting the computer system automatically such that a first operating environment is operational on the computer system;
installing the software application in the first operating environment automatically; and
executing a set of tests automatically.

2. The method of claim 1 wherein the step of executing a set of tests automatically further comprises recording the results of the executed tests.

3. The method of claim 1 wherein the step of restarting the computer system further comprises:
reconfiguring the computer system such that the first operating environment is executed when the computer system is rebooted; and
rebooting the computer system.

4. The method of claim 1 further comprising the steps of:
providing for selection of a set of tests to be executed; and
providing for selection of the first operating environment; and
wherein the step of executing a set of tests comprises executing the selected set of tests.

5. The method of claim 4 further comprising the step of:
providing for selection of a set of configurations of the software application; and
wherein the step of executing a set of tests further comprises:
for each configuration in the set of configurations:
applying the configuration; and
executing the selected set of tests.

6. The method of claim 1 further comprising the steps of:
restarting the computer system automatically such that a second operating environment is operational on the computer system;
installing the software application in the second operating environment automatically; and
executing the set of tests automatically.

7. The method of claim 6 wherein
the step of restarting the computer system automatically such that a first operating environment is operational further comprises:
reconfiguring the computer system such that the first operating environment is executed when the computer system is rebooted; and
rebooting the computer system; and
the step of restarting the computer system automatically such that a second operating environment is operational further comprises:
reconfiguring the computer system such that the second operating environment is executed when the computer system is rebooted; and
rebooting the computer system;

8. The method of claim 6 further comprising the steps of:
providing for selection of a set of tests to be executed; and
providing for selection of the first operating environment and the second operating environment; and wherein the steps of executing tests comprise executing the selected set of tests.

9. The method of claim 6 wherein the steps of executing tests further comprise recording the results of the executed tests.

10. A method for testing a software application on a computer system comprising the steps of:
restarting the computer system automatically such that a first operating environment is operational on the computer system;
installing the software application in the first operating environment automatically;
executing a set of tests automatically;
restarting the computer system automatically such that a second operating environment is operational on the computer system;
installing the software application in the second operating environment automatically; and
executing the set of tests automatically.

11. The method of claim 10 further comprising the steps of:
providing for selection of the set of tests to be executed; and
providing for selection of the first operating environment and the second operating environment; and wherein the steps of executing tests comprise executing the selected set of tests.

12. The method of claim 11 further comprising the step of:
providing for selection of a set of configurations of the software application; and
wherein the steps of executing the set of tests comprise:
for each configuration in the set of configurations:
applying the configuration; and
executing the selected set of tests.

13. A method for testing a software application on a computer system comprising the steps of:
restarting the computer system automatically such that a first operating environment is operational on the computer system;
installing the software application in the first operating environment automatically;
executing a first set of tests automatically;
restarting the computer system automatically such that a second operating environment is operational on the computer system;
installing the software application in the second operating environment automatically; and
executing a second set of tests automatically.

14. The method of claim 13 further comprising the steps of:
providing for selection of the first set of tests and the second set of tests; and
providing for selection of the first operating environment and the second operating environment.

15. The method of claim 14 further comprising the step of:
providing for selection of one or more configurations of the software application;
and wherein the step of executing the first set of tests comprises:
for each selected configuration:
applying the configuration; and
executing the first set of tests;
and the step of executing the second set of tests comprises:
for each selected configuration:
applying the configuration; and
executing the second set of tests.

16. A system for testing a software application comprising:
a general purpose computer system; and
a test configuration software application installed on the general purpose computer system wherein the test configuration software application comprises a method for testing a software application on the computer system comprising the steps of:
restarting the computer system automatically such that a first operating environment is operational on the computer system;
installing the software application in the first operating environment automatically; and
executing a set of tests automatically.

17. The method of claim 16 further comprising the steps of:
restarting the computer system automatically such that a second operating environment is operational on the computer system;
installing the software application in the second operating environment automatically; and
executing the set of tests automatically.

18. The method of claim 17 wherein
the step of restarting the computer system automatically such that a first operating environment is operational further comprises:
reconfiguring the computer system such that the first operating environment is executed when the computer system is rebooted; and
rebooting the computer system; and
the step of restarting the computer system automatically such that a second operating environment is operational further comprises:
reconfiguring the computer system such that the second operating environment is executed when the computer system is rebooted; and
rebooting the computer system;

19. The method of claim 17 further comprising the steps of:
providing for selection of a set of tests to be executed; and
providing for selection of the first operating environment and the second operating environment; and wherein the steps of executing tests comprise executing the selected set of tests.
